(19) United States
(12) Patent Application Publication
(10) Pub. No.: US 2008/0304906 A1
(43) Pub. Date: Dec. 11, 2008

(54) Creep and Corrosion Mitigating Inserts for Bolted Joints

(76) Inventor: Michael Henry Maj, Livonia, MI (US)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/760,810

(22) Filed: Jun. 11, 2007

(51) Int. Cl. F16B 2/04

(52) U.S. Cl. 403/408.1; 403/23

(57) ABSTRACT

A system for clamping a first member to a second member is disclosed in which an insert is coupled to the first member. The insert is made of a different material than the first member and has a cylindrical through hole with its centerline roughly parallel to the insert's axis. The exterior surface of the insert is roughly cylindrical along the length of the insert except near one or both ends of the insert where the outside diameter increases monotonically in the direction of one or each end of the insert. A bolt passes through the insert coupling with threads disposed in the second member. By making the insert of a material not susceptible to creep, the attachment point is not impaired if the first member suffers from creep. The bolt comes in contact with the insert and not the first member, thereby mitigating corrosion by galvanic action.

### FIELD OF THE INVENTION

A system for clamping two parts is disclosed in which (1) the material of one of the parts is composed of a material which susceptible to creep deformation when subjected to thermal cycling and (2) galvanic corrosion in bolted joints of dissimilar materials is prevented or inhibited.

### BACKGROUND OF THE INVENTION

There is a desire to reduce the weight of engine and other powertrain components to improve fuel economy. To reduce weight, many engine structural components, which may have been made from cast iron and steel in the past, have been converted to aluminum, which weighs about one-third that of iron. Further weight reduction is possible by manufacturing these same components from magnesium, which is the lightest structural metal at two-thirds the weight of aluminum. There are two potential concerns with bolted cast magnesium component attachment points, namely magnesium's susceptibility to creep and mismatches of Coefficients of Thermal Expansion for the various materials present in a joint. Most magnesium alloys exhibit unacceptable levels of creep phenomenon under thermal load in automotive engine applications. This can result in reduction of clamping force or bolt load retention causing parts to lose alignment and/or functionality. Secondly, mismatches in the thermal expansion rates of the different materials that make up an attachment point may lead to loosening in the engagement attachment joint.

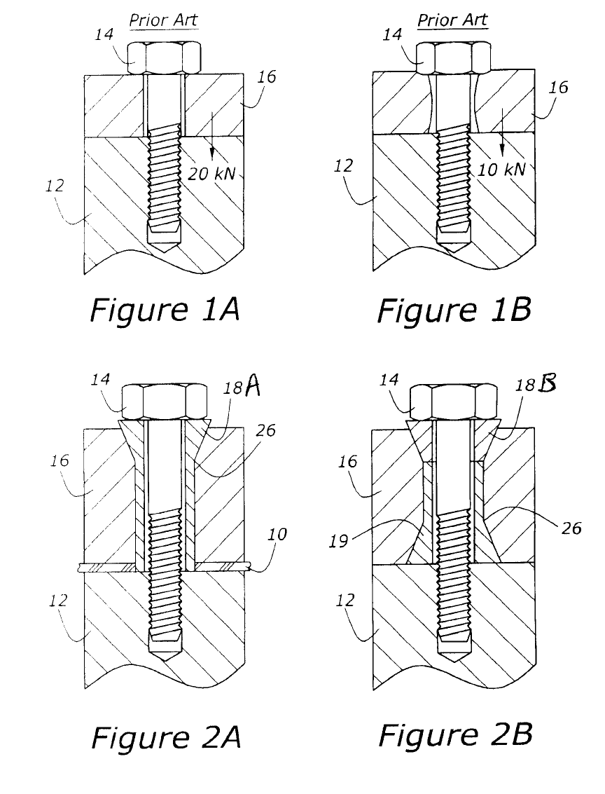

In FIG. 1a, a clamping system according to the prior art is shown in which a first part 16, made of a material which is susceptible to creep, is secured to a second part 12, made of a material in which creep is minimal, by a bolt 14. The bolt threads into structure 12. By tightening the bolt, the desired clamping force is obtained, which is 20 kN in the present example shown in FIG. 1a. After many thermal cycles in which the engine temperature can be as low as −40 deg F. and as high as 250 deg F., the first part 16 deforms near the bolt contact and the through hole due to creep and results in a lower clamping force of 10 kN, as shown in FIG. 1b. Materials which are known to be susceptible to creep are magnesium alloys, advanced composites, and reinforced plastics.

Magnesium alloys, such as AE44, are available that can withstand higher temperature cycling due to the addition of rare earth elements compared to magnesium alloys like AZ91D. However, the alloys containing rare earth elements are more expensive, have reduced castability, and are more susceptible to corrosion. It is known, in the prior art, to overcome the loosening of the clamping force is such a system by using aluminum fasteners or expensive creep-resistant magnesium alloys containing rare earth elements. However aluminum bolts are more expensive than steel bolts, require different installation equipment in an assembly plant, are less robust than steel bolts, and are prone to thread damage during handling, stripping of the threads, cross-threading during assembly, and failure from over-torque situations. The inventor of the present invention recognizes that it is preferable to use magnesium alloys without such rare earth elements, if the problem of creep could be overcome. Similarly, it is desirable, in some applications, to use plastic and composite materials if the creep problem could be overcome.

### SUMMARY OF THE INVENTION

To mitigate the effect of the creep, an insert is provided in the material that is susceptible to creep, such as magnesium. The material of the insert more closely matches the thermal expansion of the steel bolt and has a unique shape, which retains the magnesium casting, while allowing it to float or deform to the extent its volume changes during thermal cycling. The insert manages all of the clamp force while the unique taper geometry holds the magnesium casting in place.

A system for clamping a first member to a second member is disclosed in which an insert is coupled to the first member. The insert is made of a different material than the first member and has a cylindrical through hole with the centerline of the through hole roughly parallel to the axis of the insert. The exterior surface of the insert is roughly cylindrical along the length of the insert except near one or both ends of the insert where the outside diameter increases monotonically in the direction of the end of the insert. A bolt passes through the insert coupling with threads disposed in the second member. In one embodiment the first member is made of magnesium, the second member of aluminum and the bolt of steel. In alternate embodiments, the first member is made of reinforced plastic or a composite material.

The insert is cast into the first member. Alternatively, it is pressed into the first member. Or, in another embodiment, it is thermally sprayed into the first member. In the embodiment where the insert is pressed into the first member and the insert flares at both ends, the insert is made of two pieces to allow insertion into the first member.

The increase in diameter near one or both ends of the insert is linear with respect to length along the axis of said insert. Alternatively, the increase in diameter forms an arc tangent to the exterior surface to obviate stress risers in said insert.

In one embodiment, the insert sits proud of the first member, meaning that it protrudes above the first member so that the bolt head is in contact with only the insert and not the first member to prevent corrosion by galvanic action.

Also disclosed is a clamping system with a first member made from a material susceptible to creep under thermal loading. An insert is coupled to the first member. The insert is made of a different material than the first member and has a cylindrical through hole. The centerline of the through hole is roughly parallel to the axis of the insert. The exterior surface of is insert is roughly cylindrical along the length of the insert except near both ends where the outside diameter increases near the ends. A second member made from a different material than said first member is arranged to sit against both ends of said insert. A bolt is pushed into through holes in both sides of the second member and the insert. A nut threaded onto the bolt can be tightened to pull the whole system together. In one embodiment the second member wraps around the first member and is made from a single piece. In another embodiment, the second member is comprised of two pieces, one on each end of the insert. An isolating material can be placed between said first and second members.

An advantage of the present invention is that the magnesium casting is allowed to float under thermal loading, the thermally induced volumetric changes to the casting will cause less deformation in the neighborhood of the insert as that in a conventional joint of “straight” aluminum insert.

A further advantage is that the taper insert reduces the possibility of forming an electrical circuit. As a result, the aluminum tapered inserts mitigate potential effects of creep and galvanic corrosion.

Another advantage of the present invention is that current assembly tools and processes are not affected and there is no degradation of the robustness of the attachment points when switching from an aluminum bracket to a magnesium bracket. It also allows for the use of common, readily available magnesium alloys in higher temperature applications.

Yet another advantage is that in one embodiment, the insert is extended some distance beyond the surface of the magnesium casting to prevent galvanic corrosion between the steel bolt and the magnesium casting.

### BRIEF DESCRIPTION OF THE INVENTION

The advantages described herein will be more fully understood by reading an example of an embodiment in which the invention is used to advantage, referred to herein as the Detailed Description, with reference to the drawings wherein:

FIGS. 1a-b show an attachment point according to prior art clamping systems, shown before (1a) and after creep (2a) due to thermal cycling;

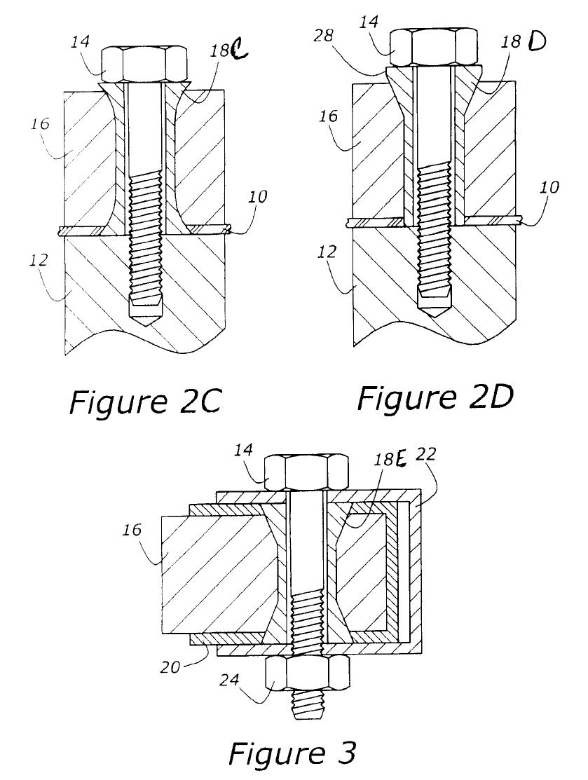

FIGS. 2a-d show non-limiting examples of the present invention utilizing an insert to mitigate the effect of creep on the attachment; and

FIG. 3 shows an additional embodiment utilizing an insert.

### DETAILED DESCRIPTION

In FIG. 2a, an insert 18 of aluminum is provided within a magnesium part 16. A bolt can be inserted through the center of insert 18. The bolt is tightened by engaging in threads provided in aluminum part 12. The joint between parts 12 and 16, in one embodiment, is separated by a gasket 10. The bolt head presses on insert 18. In one embodiment, the insert sits proud with respect to magnesium part 16. Alternatively, the insert does not protrude from magnesium part 16 (this embodiment is not shown). The exterior surface of insert 18 is cylindrical with its axis substantially collinear with the axis of the through hole in insert 18, except near the end which contacts the bolt which flares out. The diameter increases monotonically toward the end of insert 18.

In an alternative embodiment shown in FIG. 2b, the insert is shown as a two-piece part, upper piece 18 and lower piece 19. Because this insert flares out at both ends, it is not possible to press it into member 16. However, in the event that the insert is thermally sprayed or cast into place, it can be constructed of one piece, in which case upper piece 18 is not separated from lower piece 19. Also shown in FIG. 2B is an embodiment not utilizing a gasket in between the two members 16 and 12. Any of the attachments shown in the Figures could be clamped with or without a gasket. In yet another embodiment shown in FIG. 2c, insert 18 flares out smoothly to prevent a stress riser which might exist such as at 26 shown in FIG. 2a.

In FIG. 2d, insert 18 flares out, with the diameter increasing monotonically approaching the insert's end. However, there is a slight flat 28 at the extreme end portion of insert 18.

Insert 18 can be press fit into magnesium part 16 for the embodiment shown in FIG. 2a and 2d. Alternatively, insert 18 is cast into place or thermally sprayed in any of embodiment shown in FIGS. 2a-d.

In the discussion above, the material of the elements are described as: upper part of magnesium with an insert of aluminum, bolt of steel, and the lower part of aluminum. However, these described materials are by way of example and not intended to be limiting. The present invention applies to any clamping system in which material creep compromises the clamping force.

The invention is not limited to any particular clamping system. However, the inventors envision using the clamping system to hold a magnesium bracket to an aluminum cylinder head. Additional embodiments include:
basic engine structures composed of magnesium or hybrid aluminum and magnesium to facilitate the joining of cylinder heads to blocks, bed plates to blocks, crankshaft bearings to blocks, etc;
other magnesium or polymer composite engine and powertrain parts such as oil pans, valve/cam covers, front covers, intake manifolds, brackets, transmissions, transfer cases, axle carriers, etc.;
magnesium or polymer composite wheels;
joining cast magnesium or advanced polymer composite primary body structural members;
magnesium or polymer composite chassis structural members, such as frame crossmembers and subframes; and
magnesium or polymer composite suspension members (such as control arms, trailing arms, links).

The list above is provided for purposes of illustration only and is in no way intended to be limiting.

A number of embodiments of the invention have been described. Nevertheless, it will be understood that various modifications may be made without departing from the spirit and scope of the invention. Accordingly, other embodiments are within the scope of the following claims.

1. A system for clamping a first member to a second member, comprising:
an insert coupled to the first member wherein said insert is made of a different material than the first member and said insert has a cylindrical through hole with the centerline of the through hole roughly parallel to the axis of said insert and an exterior surface of said insert being roughly cylindrical along the length of said insert except near an end of said insert where the outside diameter increases monotonically in the direction of said end of said insert; and
a bolt passing through said insert coupled to the first member, the bolt coupling with threads disposed in the second member.

2. The system of claim 1 wherein the first member is made of magnesium.

3. The system of claim 1 wherein the second member is made of aluminum.

4. The system of claim 1 wherein the first member is made of a composite material.

5. The system of claim 1 wherein the first member is made of a reinforced plastic material.

6. The system of claim 1 wherein a gasket is placed between the first and second members.

7. The system of claim 1 wherein said insert is comprised of aluminum.

8. The system of claim 2 wherein said insert is cast into the first member.

9. The clamping system of claim 2 wherein said insert is pressed into the first member.

10. The system of claim 2 wherein said insert is thermally sprayed into the first member.

11. The system of claim 1 wherein said increase in diameter near said end of the insert is linear with respect to length along the axis of said insert.

12. The system of claim 1 wherein said increase in diameter forms an arc tangent to said exterior surface which is parallel to said axis of the insert, said arc obviates stress risers in said insert.

13. The system of claim 1 wherein said end of said insert with increased diameter is proximate a head of said bolt.

14. The clamping system of claim 1 wherein the outside diameter of said insert deviates from being roughly cylindrical near both ends of said insert, said outside diameter increasing monotonically in the direction of both ends of said insert.

15. The clamping system of claim 1 wherein said end of said insert proximate a head of said bolt sits proud of the first member.

16. A system for clamping a first member to a second member, comprising:
an insert coupled to the first member wherein said insert is made of a different material than the first member and said insert is radially symmetrical and has a cylindrical through hole with the centerline of the through hole roughly parallel to the axis of said insert and an exterior surface of said insert being roughly cylindrical along the length of said insert except near an end of said insert which is of a larger outside diameter; and
a bolt passing through said insert coupled to the first member, the bolt coupling with threads disposed in the second member.

17. The system of claim 16 wherein said first member is made of a magnesium alloy, said second member is made of aluminum, and said bolt is made of steel.

18. The system of claim 16 wherein said insert, in the vicinity of the bolt head protrudes above said first member.

19. A clamping system, comprising:
a first member made from a material susceptible to creep under thermal loading;
an insert coupled to said first member wherein said insert is made of a different material than said first member and said insert has a cylindrical through hole with the centerline of the through hole roughly parallel to the axis of said insert and an exterior surface of said insert being roughly cylindrical along the length of said insert except near both ends of said insert where the outside diameter increases near said insert ends;
a second member made from a different material than said first member, said second member arranged to sit against both ends of said insert;
a bolt pushed into through holes in both sides of said second member and said insert; and
a nut threaded onto said bolt.

20. The clamping system of claim 19 wherein said second member wraps around said first member and said second member is comprised a single piece.

21. The clamping system of claim 19 wherein said second member is comprised of two pieces, one on each end of said insert.

22. The clamping system of claim 19, further comprising: an isolating material placed between said first and second members.

23. A system for clamping a first member to a second member, comprising:
an insert coupled to the first member wherein said insert is made of a different material than the first member and said insert has a cylindrical through hole with the centerline of the through hole roughly parallel to the axis of said insert and an exterior surface of said insert being roughly cylindrical along the length of said insert except near both ends of said insert where the outside diameter increases monotonically in the direction of each end; and
a bolt passing through said insert coupled to the first member, the bolt coupling with threads disposed in the second member.

24. The system of claim 23 wherein said insert is comprised of two pieces and said insert is pressed fit into said first member.
